(19) United States
(12) Patent Application Publication
(10) Pub. No.: US 2025/0338350 A1
(43) Pub. Date: Oct. 30, 2025

(54) TIMING ADVANCE MANAGEMENT IN A WIRELESS SYSTEM

(71) Applicant: Nokia Technologies Oy, Espoo (FI)

(72) Inventors: Timo KOSKELA, Oulu (FI); Sami-Jukka HAKOLA, Oulu (FI); Samuli Heikki TURTINEN, Oulu (FI); Mihai ENESCU, Karakaari 13 (FI); Juha Pekka KARJALAINEN, Oulu (FI)

(21) Appl. No.: 18/860,942

(22) PCT Filed: Apr. 29, 2022
(86) PCT No.: PCT/EP2022/061475

§ 371 Date: Oct. 28, 2024

(51) Int. Cl. H04W 76/38; H04W 72/21; H04W 74/0833

(52) U.S. Cl. CPC H04W 76/38; H04W 72/21; H04W 74/0833

(57) ABSTRACT

A method includes applying, by a terminal device, timing advance adjustment information on a cell of a network node; and indicating by the terminal device and to the network node, a request for another timing advance adjustment information to be maintained on the cell. An apparatus, including at least one memory and the computer program code are configured to, with the at least one processor, cause the apparatus at least to apply, by a terminal device, timing advance adjustment information on a cell of a network node; and indicate by the terminal device and to the network node, a request for another timing advance adjustment information to be maintained on the cell.

### TECHNICAL FIELD

The examples and non-limiting example embodiments relate generally to communications and, more particularly, to timing advance management in a wireless system.

### BACKGROUND

It is known to facilitate timing mechanisms in a communication network.

### SUMMARY

In accordance with an aspect, a method includes applying, by a terminal device, timing advance adjustment information on a cell of a network node; and indicating by the terminal device and to the network node, a request for another timing advance adjustment information to be maintained on the cell.

In accordance with an aspect, a method includes transmitting, from a network node to a terminal device, configuration information including one or more conditions for triggering a request for another timing advance adjustment information to be maintained on a cell of the network node; and receiving, by the network node from the terminal device, the request for another timing advance adjustment information to be maintained by the terminal device, based on the one or more conditions.

In accordance with an aspect, an apparatus includes means for applying, by a terminal device, timing advance adjustment information on a cell of a network node; and means for indicating by the terminal device and to the network node, a request for another timing advance adjustment information to be maintained on the cell.

In accordance with an aspect, an apparatus includes means for transmitting, from a network node to a terminal device, configuration information including one or more conditions for triggering a request for another timing advance adjustment information to be maintained on a cell of the network node; and means for receiving, by the network node from the terminal device, the request for another timing advance adjustment information to be maintained by the terminal device, based on the one or more conditions.

In accordance with an aspect, a non-transitory program storage device readable by a machine, tangibly embodying a program of instructions executable with the machine for performing operations is provided, the operations including: applying, by a terminal device, timing advance adjustment information on a cell of a network node; and indicating by the terminal device and to the network node, a request for another timing advance adjustment information to be maintained on the cell.

In accordance with an aspect, a non-transitory program storage device readable by a machine, tangibly embodying a program instructions executable with the machine for performing operations is provided, the operations including: from a network node to a terminal device, transmitting, configuration information including one or more conditions for triggering a request for another timing advance adjustment information to be maintained on a cell of the network node; and receiving, by the network node from the terminal device, the request for the another timing advance adjustment information to be maintained by the terminal device, based on the one or more conditions.

In accordance with an aspect, an apparatus includes: at least one processor; and at least one memory including computer program code; wherein the at least one memory and the computer program code are configured to, with the at least one processor, cause the apparatus at least to: apply, by a terminal device, timing advance adjustment information on a cell of a network node; and indicate by the terminal device and to the network node, a request for another timing advance adjustment information to be maintained on the cell.

In accordance with an aspect, an apparatus includes: at least one processor; and at least one memory including computer program code; wherein the at least one memory and the computer program code are configured to, with the at least one processor, cause the apparatus at least to: transmit, from a network node to a terminal device, configuration information including one or more conditions for triggering a request for another timing advance adjustment information to be maintained on a cell of the network node; and receive, by the network node from the terminal device, the request for another timing advance adjustment information to be maintained by the terminal device, based on the one or more conditions.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example timing advance command MAC CE.

FIG. 3 shows an example absolute timing advance command MAC CE.

FIG. 4 shows an example of inter-cell mTRP communication.

FIG. 5 is an example apparatus configured to implement the examples described herein.

FIG. 6 is an example method performed with a user equipment to implement the examples described herein.

FIG. 7 is an example method performed with a network node to implement the examples described herein.

### DETAILED DESCRIPTION OF EXAMPLE EMBODIMENTS

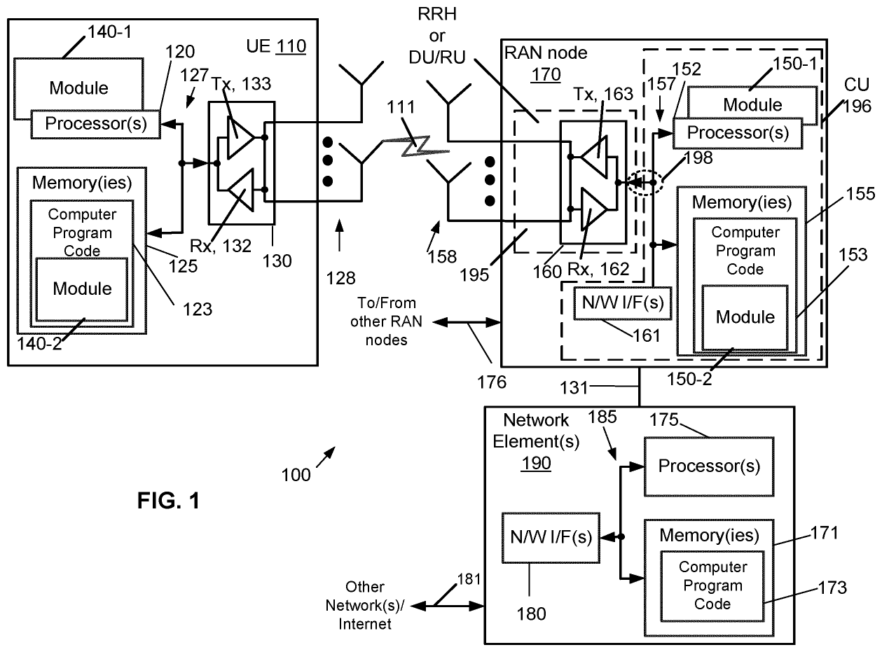

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The qNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly in controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A relay node in NR is called an integrated access and backhaul node. A mobile termination part of the IAB node facilitates the backhaul (a.k.a. parent link) connection. In other words, it's the functionality which carries UE functionalities. The distributed unit part of the IAB node facilitates the so called access link (a.k.a. child link) connections (i.e. for access link UEs, and backhaul for other IAB nodes, in the case of multi-hop IAB). In other words, it's responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing These are merely example functions network) functionality. that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

UE 110, RAN node 170, and/or network element(s) 190, (and associated memories, computer program code and modules) may be configured to implement (e.g. in part) the methods described herein, including timing advance management in a wireless system. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

The examples described herein relate to the feMIMO evolution work item in RAN1. More specifically the examples described herein relate to multi-TA maintenance/operation.

RAN1 includes several work items related to the examples described herein (1-7 immediately following, with emphasis on item 7).

1. Study, and if justified, specify CSI reporting enhancement for high/medium UE velocities by exploiting time-domain correlation/Doppler-domain information to assist DL precoding, targeting FR1, as follows: a) Rel-16/17 Type-II codebook refinement, without modification to the spatial and frequency domain basis, and b) UE reporting of time-domain channel properties measured via CSI-RS for tracking.

2. Specify extension of the Rel-17 unified TCI framework for indication of multiple DL and UL TCI states focusing on the multi-TRP use case, using the Rel-17 unified TCI framework.

3. Study, and if justified, specify a larger number of orthogonal DMRS ports for downlink and uplink MU-MIMO (without increasing the DM-RS overhead), only for CP-OFDM, a) striving for a common design between DL and UL DMRS, and b) up to 24orthogonal DM-RS ports, where for each applicable DMRS type, the maximum number of orthogonal ports is doubled for both single-symbol DMRS and double-symbol DMRS.

4. Study, and if justified, specify enhancements of CSI acquisition for coherent-JT targeting FR1 and up to 4 TRPs, assuming ideal backhaul and synchronization as well as the same number of antenna ports across TRPs, as follows: a) Rel-16/17 Type-II codebook refinement for CJT mTRP targeting FDD and its associated CSI reporting, taking into account the throughput-overhead trade-off; b) SRS enhancement to manage inter-TRP cross-SRS interference targeting TDD CJT via SRS capacity enhancement and/or interference randomization, with the constraints that 1) without consuming additional resources for SRS, 2) reuse existing SRS comb structure, and 3) without new SRS root sequences; and c) noting the maximum number of CSI-RS ports per resource remains the same as in Rel-17, i.e. 32.

5. Study, and if justified, specify UL DMRS, SRS, SRI, and TPMI (including codebook) enhancements to enable 8 Tx UL operation to support 4 and more layers per UE in UL targeting CPE/FWA/vehicle/industrial devices. Potential restrictions on the scope of this objective (including coherence assumption, full/non-full power modes) are to be identified as part of the study.

6. Study, and if needed, specify the following items to facilitate simultaneous multi-panel UL transmission for higher UL throughput/reliability, focusing on FR2 and multi-TRP, assuming up to 2 TRPs and up to 2 panels, targeting CPE/FWA/vehicle/industrial devices (if applicable): a) UL precoding indication for PUSCH, where no new codebook is introduced for multi-panel simultaneous transmission. The total number of layers is up to four across all panels and the total number of code words is up to two across all panels, considering single DCI and multi-DCI based multi-TRP operation; b) UL beam indication for PUCCH/PUSCH, where unified TCI framework extension in objective 2 is assumed, considering single DCI and multi-DCI based multi-TRP operation. For the case of multi-DCI based multi-TRP operation, only PUSCH+PUSCH, or PUCCH+PUCCH is transmitted across two panels in a same CC.

7. Study, and if justified, specify the following: a) two TAs for UL multi-DCI for multi-TRP operation, and b) power control for UL single DCI for multi-TRP operation where unified TCI framework extension in objective 2 is assumed. For the case of simultaneous UL transmission from multiple panels, the operation is to only be limited to the objective 6 scenarios.

### Timing Advance Command MAC CE

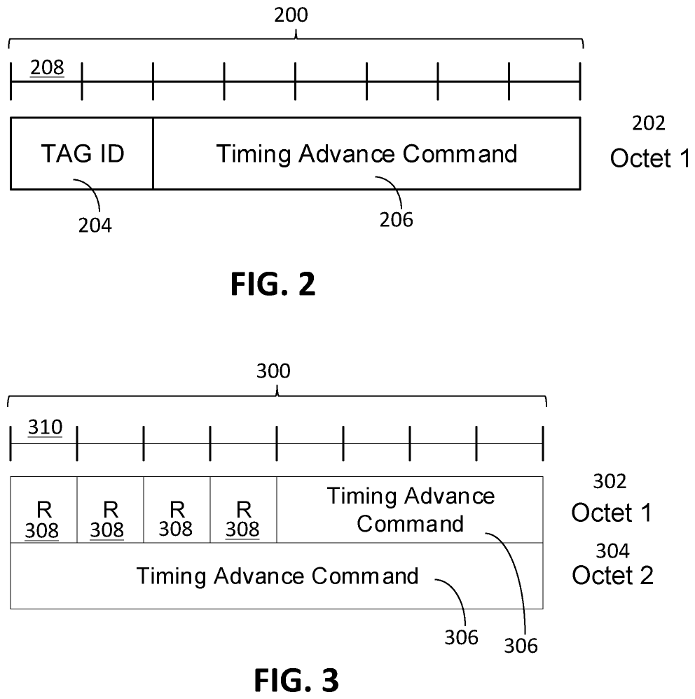

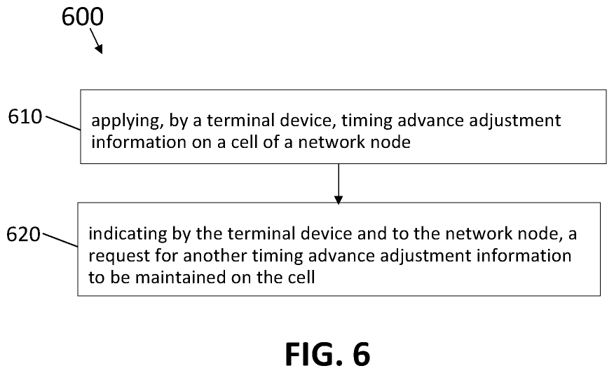

With reference to FIG. 2, the Timing Advance Command MAC CE 200 is identified by a MAC subheader with a logical channel ID (LCID) as specified in 3GPP TS 38.321 V17.0.0 (2022-03). The Timing Advance Command MAC CE 200 has a fixed size and consists of a single octet 202 defined as follows (FIG. 6.1.3.4-1: Timing Advance Command MAC CE, as shown in FIG. 2): a) TAG Identity (TAG ID) 204. The TAG ID field 204 indicates the TAG Identity of the addressed TAG. The TAG containing the SpCell has the TAG Identity 0. The length of the field is 2 bits; b) Timing Advance Command 206. The timing advance command field 206 indicates the index value TA (0, 1, 2 . . . 63) used to control the amount of timing adjustment that the MAC entity has to apply (as specified in TS 38.213). The length of the timing advance command field 206 is 6 bits. As shown in FIG. 2, the bit demarcation is indicated as item 208.

### Absolute Timing Advance Command MAC CE

With reference to FIG. 3, the Absolute Timing Advance Command MAC CE 300 is identified by a MAC subheader with an eLCID as specified in 3GPP TS 38.321 V17.0.0 (2022-03) b. The Absolute Timing Advance Command MAC CE 300 has a fixed size and consists of two octets (302, 304) defined as follows (Absolute Timing Advance Command MAC CE, as shown in FIG. 3): a) Timing Advance Command 306. The timing advance command field 306 indicates the index value TA used to control the amount of timing adjustment that the MAC entity has to apply in TS 38.213. The size of the timing advance command field 306 is 12 bits; b) R 308: Reserved bit, set to “0”. As shown in FIG. 3, the bit demarcation is indicated as item 310.

The unified TCI framework in R17 is as follows. On the unified TCI framework, the following aspects have been clarified and/or agreed to in RAN1 (including for RAN node 170) so far: a) Common TCI state (a.k.a. indicated TCI) for a set of signals and channels at a time, b) TCI state can be joint DL/UL, separate DL TCI state and separate UL TCI state, c) RRC configures a set (or pool) of joint and/or separate TCI states, d) MAC activates a number (e.g. 8) of joint and/or separate TCI states. Before the first indication, the first activated TCI state is the current indicated TCI state, e) DCI indicates one of the activated TCI states to be the indicated TCI state (which may be a common TCI state).

On the DCI-based TCI state indication, the following has been agreed so far. DCI format 1_ 1/1_2 with and without DL assignment is used to carry the TCI state indication. The indication is confirmed by a HARQ ACK by the UE. Application time of the beam indication is the first slot that is at least X ms or Y symbols after the last symbol of the acknowledgment of the joint or separate DL/UL beam indication. TCI field codepoint may be joint or separate. Joint TCI field codepoint may include TCI state for both DL and UL. Separate TCI field codepoint includes a pair of DL TCI state and UL TCI state, a DL TCI state (keep the current UL TCI state), and an UL TCI state (keep the current DL TCI state).

Currently the UE can obtain the timing advance (e.g. when it does not have TA) during a random access procedure. As an example in the CBRA (contention based random access) procedure the UE transmits a random access preamble, and in a random access response, the network provides the UE with an absolute timing advance command (TAC). To keep adjusting the timing advance, the network may periodically update the timing advance for the UE by sending the TAC, which in turn restarts/starts the time alignment timer.

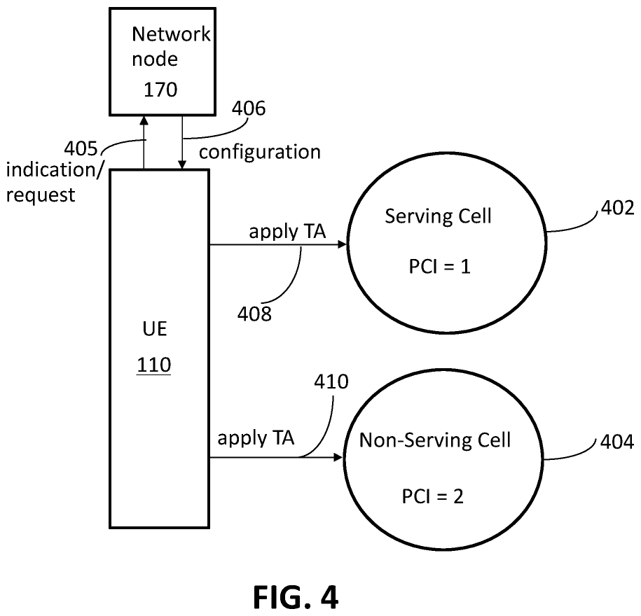

Currently there is no support for having multiple TA values per serving cell (in one serving cell or in inter-cell beam management or in multiple TRP communication). In inter- cell communication (inter-cell beam management or inter-cell multiple TRP communication), with reference to FIG. 4, the UE 110 may be configured to communicate with a serving cell 402 and one or more cells 404 having a different PCI (PCI=2) than the serving cell 402 (PCI=1). The cell 404 that has a PCI (PCI=2) different from that of a serving cell 402 (PCI=1) may communicate with the UE 110 but may not be configured as a serving cell e.g. as in carrier aggregation where each cell can be referred to as a serving cell. The UE 110 may be configured with multiple TA groups, and the multiple TA groups may include one or more serving cells. However for a single TA group, the UE 110 may only maintain a single TA for each cell.

A 38.321 technical standard compliant UE can be configured with multiple timing advance groups (TAGs), and each TAG may have one or more serving cells (refers to carrier aggregation).

The examples described herein are directed to enhancing the current TA framework by proposing UE initiated actions to aid the network for the configuration of a second TA value to be maintained (e.g. the network e.g., RAN 170 see FIGS. 2, 4 may periodically adjust one or more TA values for the UE 110).

In a main example, with reference to FIG. 4, the UE 110 may be configured to indicate the information related to the timing advance management (TAI, timing advance information) in the current serving cell 402. In any of the examples, the (serving) cell may be comprised of a serving cell 402 (PCell or an SCell) and a cell (an additional cell or assisting cell) 404 with a different PCI than the serving cell, or a cell which may be used for communicating with the UE 110. The cell (e.g., 404) with the different PCI (PCI=2) may be associated with a specific serving cell (e.g., 402 with PCI=1), when the cell (e.g., 404) with the different PCI is configured by the serving cell (e.g., 402) or is part of the serving cell configuration. In other words, the cell with a different PCI than the serving cell (e.g. the additional cell assisting cell) can be a cell used for inter-cell beam management cell or inter-cell mTRP. The indication may be provided during a contention based random access procedure, e.g. in a msg. 3 where the msg. 3 may include a MAC CE for the indication. The indication may be provided to the serving cell (e.g., 402) or the cell (e.g., 404) with a different PCI than the serving cell. The indication may be provided to the serving cell or the cell with a different PCI than the serving cell in a random access procedure. The indication may be provided after the contention based random access procedure, e.g. in a separate uplink MAC CE. The indication may be provided in an uplink control message, e.g. a MAC CE on a PUSCH. The MAC CE may also be multiplexed to a UL grant on a PUSCH. The indication may be provided in an uplink control message/channel such as PUCCH, e.g. using a PUCCH format carrying the indication information or using a PUCCH.

More specifically, the indication may be triggered based on UE determined conditions and/or thresholds, wherein the configuration for the triggering may be provided by the network (e.g. using RRC signaling). In the indication the UE may provide information that specific conditions may have been triggered with respect to the timing advance information (TAI) and the UE 110 may request/indicate that a second TA value (second TA loop) for the serving cell 402 would be needed.

One or more conditions may include one or more of the following (1-2 immediately following, where they can be joint conditions):

1) The UE observing a downlink timing difference between one or more downlink reference signals (RS) with respect to the timing used for the first/current TA value (TA loop). A timing difference threshold may be configured to be e.g. X nanoseconds or X microseconds. The timing difference threshold may be a multiple (N times) of TA steps, N*TA (or e.g. N*x nanoseconds).

2) Different UE antenna panels may be associated with the activated TCI states for UL transmission (but not yet indicated e.g. the UE is not yet currently configured to use the UL or joint DL/UL transmission or right after the indication for the UE to use multiple uplinks). Alternatively, the condition may be the indication of the activated TCI state for UL or joint DL/UL transmission. An indication may refer to an operation where the UE applies the indicated TCI state for transmission/reception. In other words, the network may configure the UE with multiple uplink links (or joint DL/UL) and activate one or more of those links also so that there may be scheduling for simultaneous transmission. The links may be transmitted with different antenna panels and a different DL RS is used as reference for the UL transmission (thus if the timing difference is above a threshold value, the UE may need to maintain/apply multiple TA values).

When the UE determines that the configured trigger conditions apply, the UE triggers the transmission of the indication (e.g. a MAC CE).

In one example, if the UE (e.g. UE 110) initiates a random access procedure (e.g. for buffer status reporting purposes) it may indicate during the random access procedure or right after (e.g. in a MAC CE in msg. 3) which TA value (the maintained TA loop e.g. the first loop or second loop) the DL RS selected in a random access procedure is associated with. This indicates to the network that which of the maintained TA values (TA loops) the UE may be associated to the selected DL RS for random access.

In an example, the TAI may include an indication that the RS selected for the random access procedure (e.g. CBRA) is considered as part of the specific TA value that is maintained by the UE (the TA loop).

The request may indicate to the network (NW node 170) to configure another timing adjustment loop (e.g. a second loop) for communication purposes and/or indicate that a specific downlink reference signal may be observed to be received by the UE with a different timing with respect to the current observed downlink timing (based on the current timing for the first loop). This may be indicated by using a TAI value that is different from the currently used value.

In one embodiment, the UE may be configured to trigger an indication for a second TA value (TA loop) when the UE receives a MAC CE activation for at least a second TCI state or more than one TCI State and the UE observes, from the perspective of the UE, a timing difference for the downlink reference signal (DL RS) indicated by a first TCI state and the second TCI state (qcl-typeD if there are multiple) may exceed a configured threshold or satisfy a condition or criteria. Alternatively, as one condition, when the UE determines that it is configured with more than one CORESETPoolIndex (indicating that the UE is configured with mTRP communication) it may be configured to trigger TAI indication to the network. The configured threshold, or condition or criteria may e.g. be that the TA difference is more than X nanoseconds/microseconds and so on. The configured threshold, or condition or criteria may e.g. be that the TA difference is more than N number of TA steps TA (0, 1, 2 . . . 63) between DL RSs that are associated with the PUCCH/PUSCH transmission for the UE (e.g. two unified TCI States).

In one embodiment, a configured condition for indicating the need for a second TA value (TA loop) may be conditioned as follows. The network may activate at least a second TCI state or multiple TCI states. The network may indicate (in addition to activation) at least a second TCI state. In an alternative, the network may activate at least a second TCI state or multiple TCI states and the UE observes the timing difference (more than N steps, or N nanoseconds) for the DL RS with respect to the first TA value (TA loop or TA reference timing). The second TCI may have a RS with a different PCI than the serving cell, or at least two TCI states have association with different PCIs (e.g. one serving and one PCI different than the serving cell). For example, in consideration of the inter-cell beam management/mTRP, in one example, the UE may determine the need for initiating a second TA loop when it receives a MAC CE that activates a unified TCI state that is a joint DL/UL or separate UL TCI state for beam indication and where the RS indicated by the TCI state is associated with a PCI different from the serving cell PCI.

A configured condition for indicating a need for a second TA loop may be conditioned on different UE panels associated with the active TCI States for UL transmission.

In one embodiment, if the UE observes a TA difference above a threshold value for the current TA value (TA loop), the UE may trigger a CBRA procedure. In one option, the UE may be required to select the DL RS (or one of the DL RS e.g. SSB) for the CBRA for which the timing difference was observed (e.g. number of TA steps that the UE is allowed/capable to adjust by itself) for the CBRA and indicate the TAI (e.g. the first maintained TA value or the second maintained TA value in the MAC CE. The selection of the SSB may be further conditioned to a specific RSRP threshold.

In any of the embodiments, if the UE is configured to determine whether the timing difference condition is fulfilled, it may determine to use the current timing used for UL transmission e.g. with respect to the reference RS (reference signals) or use the TA value (the timing advance value associated with the first maintained TA value). Other methods are not excluded.

In one embodiment, the TAI information may include an indication or information on one or more maintained TA values. As an example, if the UE 110 includes information indicating a second TA value (i.e., another TA value), this may indicate to the network node 170 that the message or transmission is for maintaining of or requesting for an additional TA value. The TAI information, e.g. in a MAC CE may include a bitmap of N bits e.g. 2 where the one bit field provides information for the first TA value (TA loop 1) and one field provides information for the second TA value (TA loop 2). One value of the bit (e.g. 0) means that the UE does not need TA for the associated loop. Another value of the bit (e.g. 1) means that UE 110 may need another TA for the associated loop. The TAI information, e.g. in a MAC CE may comprise a bitmap of N bits e.g. 1 bit, where the 1 bit field may provide information for the second TA value (TA loop 2). The information may be a request for maintaining a second TA value (e.g. for UL communication). As an example, the TAI information may include at least one (e.g. 1 bit) field indicating that a second TA value is to be maintained. In one embodiment, the TAI information in the MAC CE may include a 1 bit field, wherein one value indicates a TA value to be maintained (TA loop, e.g. bit value=0 for the first loop and bit value=1 for the second loop or vice versa).

In one embodiment, in any of the embodiments, the indication for maintaining a TA value may refer to a request for a second TA value to be maintained. Alternatively the maintaining may refer to a request for updating a TA value for a specific maintained TA value (TA loop). In one example, in absence of any TA indication, the UE 110 may not be required to apply the TA command for a specific TA loop. In one example, the UE 110 may use the given TA value in msg. 2 for subsequent UL transmissions during the random access procedure.

In one embodiment, the UE is configured with the following condition to include the TAI information MAC CE to the msg. 3 or provide it as part of or after the random access procedure: if the selected RS for the CBRA procedure does not correspond to any DL RS that is configured as active TCI state associated with a specific TA value that is maintained (TA loop), the UE does not include the TAI MAC CE in the msg. 3. In this case, the UE may not apply the provided TA for any of the loops but may use it during the RA procedure. In any of the embodiments, a bit field, or a set of fields providing the TAI information may be a (new) MAC CE or part of an existing MAC CE.

In one embodiment, the MAC CE may further include indication of an identifier or multiple identifiers of one or more DL RS set identifiers that for which the UE requests the association with a second TA value (TA loop). Wherein, the identifier(s) of DL RS(s) may be different than the selected DL RS for CBRA. In a case where any of the indicated DL RS do not correspond to the selected DL RS for RA, the UE may expect the NW to trigger PDCCH order to maintain the second TA value. The DL RS may be indicated by referring the TCI state or TCI state index (e.g. listed in a MAC CE). The DL RS that may be indicated may be the RS used as a spatial relation for one or more UL channels/signals. The indicated list of DL RS may include a list of SSB index values.

In one embodiment, the MAC CE may include an indication of (a) DL RS set identifier(s), wherein the UE may request an association with a specific TA value (a TA loop identifier, e.g. a first or second TA value). As an example, the MAC CE may include an indication of (a) DL RS set identifier(s) wherein the UE may request an association with a second TA value (TA loop). The DL RS sets may be configured by the network (e.g. set #1 may have DLRS #1 and DLRS #2, and set #2 may have DLRS #3 and DLRS #4 and so on). One DL RS set may have one or more DL RS. The UE may determine that at least one condition for triggering the indication (e.g. the association of a DL RS set with a TA loop) of a DL RS set is fulfilled when at least one DL RS fulfills a condition described herein (e.g. the observed DL timing difference with respect to a reference DL resource.). In some examples, all the DL RS in the set may have to fulfill a condition (e. g. a timing difference condition). As an example the timing difference condition may be The UE observing a downlink timing difference between one or more downlink reference signals (RS) with respect to the timing used for the uplink timing (e.g. the timing used for first/current/another TA value).

In one embodiment, when the UE has determined that a TAT (time alignment timer, which upon expiry the UE cannot consider to be time aligned for UL transmission) for the specific TA loop has expired, but it selects the DLRS for the CBRA procedure to be the RS associated with a different loop than the expired loop, the expired loop may be indicated in the MAC CE.

In one embodiment, when the UE has determined that a TAT (time alignment timer, which upon expiry the UE cannot consider to be time aligned for UL transmission) for the specific TA loop has expired, but it selects the DLRS for the CBRA procedure to be the RS associated with a different loop than the expired loop, the UE may indicate the loop that is associated with the DL RS e.g. in the MAC CE.

In one embodiment, considering inter-cell beam management/mTRP, in one example, the UE may determine the need for maintaining a second TA value (TA loop) when it receives the MAC CE that activates a unified TCI state that is joint DL/UL or separate UL TCI state for beam indication and where the RS indicated by the TCI state is associated with PCI different from the serving cell PCI, or when the UE receives an indication of TCI state (joint DL/UL or separate UL).

The benefit is that by relying on the UE indication, the network can be assisted with the configuration of multiple TA values (TA loops) based on the UE observed conditions.

In one example embodiment, the TA loop may refer to a Timing Advance value that may be periodically adjusted by the network node 170 and/or maintained by UE 110. The UE 110 may have or may be configured to apply one or more timing advance values per serving cell for specific UL signals/channels that are transmitted to the serving cell or to the serving cell and cell with the different PCI than the serving cell. As an example, the UE may transmit one uplink signal/channel using a first TA value (maintained by the TA loop/procedure of a periodic/aperiodic adjustment indication and/or UE adjustment) and the UE may transmit a second uplink signal/channel using a second TA value (maintained by the TA loop/procedure of a periodic/aperiodic adjustment indication and/or UE adjustment). The values may separately be controlled by the network (e.g. using periodic TA commands, specific for the maintained timing advance value (first or second). In one implementation, the serving cell timing advance values may include applying at least one timing advance value for a cell with a different PCI than the serving cell. A cell 404 with a different PCI than that of the serving cell 402 may be referred to as inter-cell mTRP communication or inter-cell beam management (i.e. the cell parameters of a cell with the different PCI is configured in the serving cell configuration or as a part of the configuration).

In one example embodiment, UE may indicate/include the TAI information during the random access procedure (e.g. in the msg. 3) when the random access procedure is initiated by PDCCH order (i.e. network triggered random access procedure). The random access procedure may be a contention based RA procedure.

In one example embodiment, information received by the UE 110 with respect timing advance during the RA procedure (e.g. in msg. 2 and/or msg. 4), or after the RA procedure, may be associated with the indicated TAI (e.g. first or second TA loop). As an example, if UE 110 receives a TAC in msg. 2 and then indicates the TAI in msg. 3 it may associate the TA command with the indicated TAI (e.g. first or second TA loop). Alternatively, or additionally, the UE may be provided by the network TAC (absolute or relative) in the msg. 4. The TAC in msg. 4 may be provided as a response to the TAI indication in msg. 3. In one example, the msg. 4 TA information may be associated with the indicated TAI. As a further example, the UE may use the TAC received in the msg. 2 of the RA procedure for subsequent transmissions and may receive further information from the network that the provided TA value in the TAC command is associated with the specific TA loop (e.g. first or second).

Thus, FIG. 4 shows an example of inter-cell mTRP communication may include the UE 110, a serving cell 402 having a PCI value of 1, and a non-serving cell 404 having a PCI value of 2, different from that of the serving cell 402. As shown in FIG. 4, at 405 the terminal device 110 indicates to the network node 170, a request for TA loop timing advance adjustment information to be maintained on the cell, either serving cell 402 or non-serving cell 404. At 406, the UE 110 receives, from the network node 170, configuration information on one or more conditions that trigger or cause application of timing advance adjustment information. At 408, the terminal device 110 may apply timing advance adjustment information on the serving cell 402 of the network node 170. At 410, the terminal device 110 may apply timing advance adjustment information on the non-serving cell 404 of the network node 170.

The examples described herein may serve as a potential contribution to release-18 discussions in RAN1 #109.

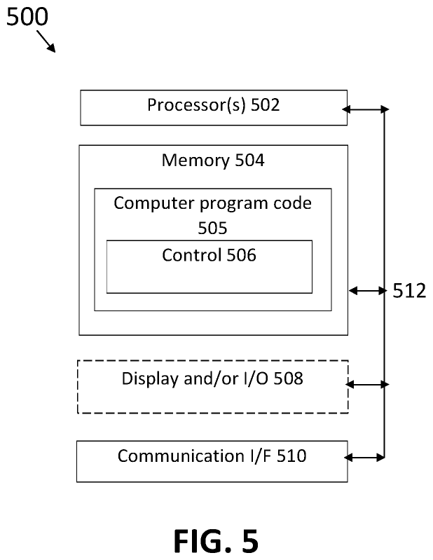

FIG. 5 is an example apparatus 500, which may be implemented in hardware, configured to implement the examples described herein. The apparatus 500 includes at least one processor 502 (e.g. an FPGA and/or CPU), at least one memory 504 including computer program code 505, wherein the at least one memory 504 and the computer program code 505 are configured to, with the at least one processor 502, cause the apparatus 500 to implement circuitry, a process, component, module, or function (collectively control 506) to implement the examples described herein, including timing advance management in a wireless system. The memory 504 may be a non-transitory memory, a transitory memory, a volatile memory (e.g. RAM), or a non-volatile memory (e.g. ROM).

The apparatus 500 optionally includes a display and/or I/O interface 508 that may be used to display aspects or a status of the methods described herein (e.g., as one of the methods is being performed or at a subsequent time), or to receive input from a user such as with using a keypad, camera, touchscreen, touch area, microphone, biometric recognition, etc. The apparatus 500 includes one or more communication e.g. network (N/W) interfaces (I/F(s)) 510. The communication I/F(s) 510 may be wired and/or wireless and communicate over the Internet/other network(s) via any communication technique. The communication I/F(s) 510 may include one or more transmitters and one or more receivers. The communication I/F(s) 510 may include standard well-known components such as an amplifier, filter, frequency-converter, (de)modulator, and encoder/decoder circuitries and one or more antennas.

The apparatus 500 to implement the functionality of control 506 may be UE 110, RAN node 170 (e.g. gNB), or network element(s) 190. Thus, processor 502 may correspond to processor(s) 120, processor(s) 152 and/or processor(s) 175, memory 504 may correspond to memory (ies) 125, memory (ies) 155 and/or memory (ies) 171, computer program code 505 may correspond to computer program code 123, module 140-1, module 140-2, and/or computer program code 153, module 150-1, module 150-2, and/or computer program code 173, and communication I/F(s) 510 may correspond to transceiver 130, antenna(s) 128, transceiver 160, antenna(s) 158, N/W I/F(s) 161, and/or N/W I/F(s) 180. Alternatively, apparatus 500 may not correspond to either of UE 110, RAN node 170, or network element(s) 190, as apparatus 500 may be part of a self-organizing/optimizing network (SON) node, such as in a cloud.

The apparatus 500 may also be distributed throughout the network (e.g. 100) including within and between apparatus 500 and any network element (such as a network control element (NCE) 190 and/or the RAN node 170 and/or the UE 110).

Interface 512 enables data communication between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code 505, including control 506 may include object-oriented software configured to pass data/messages between objects within computer program code 505. The apparatus 500 need not include each of the features mentioned, or may include other features as well.

FIG. 6 is an example method 600 to implement the example embodiments described herein. At 610, the method includes applying, by a terminal device, timing advance adjustment information on a cell of a network node. At 620, the method includes indicating by the terminal device and to the network node, a request for another timing advance adjustment information to be maintained on the cell. Method 600 may be performed with a user equipment (e.g. UE 110).

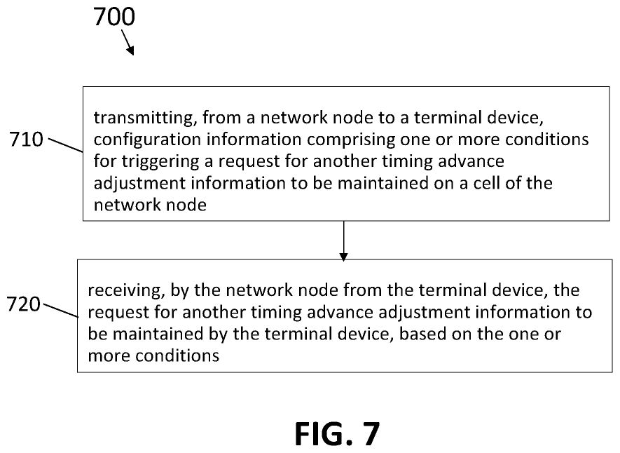

FIG. 7 is an example method 700 to implement the example embodiments described herein. At 710, the method includes transmitting, from a network node to a terminal device, configuration information including one or more conditions for triggering a request for another timing advance adjustment information to be maintained on a cell of the network node. At 720, the method includes receiving, by the network node from the terminal device, the request for another timing advance adjustment information to be maintained by the terminal device, based on the one or more conditions. Method 700 may be performed with a network node (e.g. RAN node 170).

The following examples (1-88) are provided and described herein.

Example 1: A method includes applying, by a terminal device, timing advance adjustment information on a cell of a network node; and indicating by the terminal device and to the network node, a request for another timing advance adjustment information to be maintained on the cell.

Example 2: The method according to example 1, including: indicating to the network node, the request during a random access procedure in the cell.

Example 3: The method according to example 2, including: transmitting the request via a MAC CE in a message 3 associated with the random access procedure.

Example 4: The method according to example 1, including: indicating to the network node, the request after a random access procedure in the cell.

Example 5: The method according to any of examples 1 to 4, wherein the cell includes a serving cell or a cell with a Physical Cell ID (PCI) different from a PCI of the serving cell.

Example 6: The method according to example 4, including: transmitting the request via an uplink MAC CE in the cell.

Example 7: The method according to example 6, wherein the uplink MAC CE is multiplexed to or transmitted on an uplink grant on PUSCH in the cell.

Example 8: The method according to example 1, including: determining one or more conditions for triggering the request; and transmitting the request based on the determined one or more conditions.

Example 9: The method according to example 8, including: receiving, from the network node, configuration information on the one or more conditions.

Example 10: The method according to example 9, wherein the configuration information on the one or more conditions is received via RRC signaling or a downlink MAC CE.

Example 11: The method according to example 1, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 12: The method according to example 11, wherein the current observed downlink timing is based on the timing advance adjustment information on the cell.

Example 13: A method, including: transmitting, from a network node to a terminal device, configuration information including one or more conditions for triggering a request for another timing advance adjustment information to be maintained on a cell of the network node; and receiving, by the network node from the terminal device, the request for another timing advance adjustment information to be maintained by the terminal device, based on the one or more conditions.

Example 14: The method according to example 13, including: receiving from the terminal device, the request during a random access procedure in the cell.

Example 15: The method according to any of examples 13 to 14, wherein the cell includes a serving cell or a cell with a PCI different from a PCI of the serving cell.

Example 16: The method according to example 14, including: receiving the request via a MAC CE in a message 3 associated with the random access procedure.

Example 17: The method according to example 13, including: receiving from the terminal device, the request after a random access procedure in the cell.

Example 18: The method according to example 17, including: receiving the request via an uplink MAC CE in the cell.

Example 19: The method according to example 18, wherein the uplink MAC CE is multiplexed to an uplink grant on PUSCH in the cell.

Example 20: The method according to example 13, wherein the configuration information on the one or more conditions is transmitted via RRC signaling or downlink MAC CE.

Example 21: The method according to example 13, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 22: The method according to example 21, wherein the current observed downlink timing is based on the timing advance adjustment information on the cell.

Example 23: An apparatus including: means for applying, by a terminal device, timing advance adjustment information on a cell of a network node; and means for indicating by the terminal device and to the network node, a request for another timing advance adjustment information to be maintained on the cell.

Example 24: The apparatus according to example 23, including: means for indicating to the network node, the request during a random access procedure in the cell.

Example 25: The apparatus according to example 24, including: means for transmitting the request via a MAC CE in a message 3 associated with the random access procedure.

Example 26: The apparatus according to example 23, including: means for indicating to the network node, the request after a random access procedure in the cell.

Example 27: The apparatus according to any of examples 23 to 26, wherein the cell includes a serving cell or a cell with a Physical Cell ID (PCI) different from a PCI of the serving cell.

Example 28: The apparatus according to example 26, including: means for transmitting the request via an uplink MAC CE in the cell.

Example 29: The apparatus according to example 28, wherein the uplink MAC CE is multiplexed to or transmitted on an uplink grant on PUSCH in the cell.

Example 30: The apparatus according to example 23, including: means for determining one or more conditions for triggering the request; and means for transmitting the request based on the determined one or more conditions.

Example 31: The apparatus according to example 30, including: means for receiving, from the network node, configuration information on the one or more conditions.

Example 32: The apparatus according to example 31, wherein the configuration information on the one or more conditions is received via RRC signaling or a downlink MAC CE.

Example 33: The apparatus according to example 23, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 34: The apparatus according to example 33, wherein the current observed downlink timing is based on the timing advance adjustment information on the cell.

Example 35: An apparatus, including: means for transmitting, from a network node to a terminal device, configuration information including one or more conditions for triggering a request for another timing advance adjustment information to be maintained on a cell of the network node; and means for receiving, by the network node from the terminal device, the request for another timing advance adjustment information to be maintained by the terminal device, based on the one or more conditions.

Example 36: The apparatus according to example 35, including: means for receiving from the terminal device, the request during a random access procedure in the cell.

Example 37: The apparatus according to any of examples 35 to 36, wherein the cell includes a serving cell or a cell with a PCI different from a PCI of the serving cell.

Example 38: The apparatus according to example 36, including: means for receiving the request via a MAC CE in a message 3 associated with the random access procedure.

Example 39: The apparatus according to example 35, including: means for receiving from the terminal device, the request after a random access procedure in the cell.

Example 40: The apparatus according to example 39, including: means for receiving the request via an uplink MAC CE in the cell.

Example 41: The apparatus according to example 40, wherein the uplink MAC CE is multiplexed to an uplink grant on PUSCH in the cell.

Example 42: The apparatus according to example 35, wherein the configuration information on the one or more conditions is transmitted via RRC signaling or downlink MAC CE.

Example 43: The apparatus according to example 35, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 44: The apparatus according to example 43, wherein the current observed downlink timing is based on the timing advance adjustment information on the cell.

Example 45: A non-transitory program storage device readable by a machine, tangibly embodying a program of instructions executable with the machine for performing operations, the operations including: applying, by a terminal device, timing advance adjustment information on a cell of a network node; and indicating by the terminal device and to the network node, a request for another timing advance adjustment information to be maintained on the cell.

Example 46: The non-transitory program storage device according to example 45, the operations including: indicating to the network node, the request during a random access procedure in the cell.

Example 47: The non-transitory program storage device according to example 46, the operations including: transmitting the request via a MAC CE in a message 3 associated with the random access procedure.

Example 48: The non-transitory program storage device according to example 45, the operations including: indicating to the network node, the request after a random access procedure in the cell.

Example 49: The non-transitory program storage device according to any of examples 45 to 48, wherein the cell includes a serving cell or a cell with a Physical Cell ID (PCI) different from a PCI of the serving cell.

Example 50: The non-transitory program storage device according to example 48, the operations including: transmitting the request via an uplink MAC CE in the cell.

Example 51: The non-transitory program storage device according to example 50, wherein the uplink MAC CE is multiplexed to or transmitted on an uplink grant on PUSCH in the cell.

Example 52: The non-transitory program storage device according to example 45, the operations including: determining one or more conditions for triggering the request; and transmitting the request based on the determined one or more conditions.

Example 53: The non-transitory program storage device according to example 52, the operations including: receiving, from the network node, configuration information on the one or more conditions.

Example 54: The non-transitory program storage device according to example 53, wherein the configuration information on the one or more conditions is received via RRC signaling or a downlink MAC CE.

Example 55: The non-transitory program storage device according to example 45, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 56: The non-transitory program storage device according to example 55, wherein the current observed downlink timing is based on the timing advance adjustment information on the cell.

Example 57: A non-transitory program storage device readable by a machine, tangibly embodying a program of instructions executable with the machine for performing operations, the operations including: transmitting, from a network node to a terminal device, configuration information including one or more conditions for triggering a request for another timing advance adjustment information to be maintained on a cell of the network node; and receiving, by the network node from the terminal device, the request for another timing advance adjustment information to be maintained by the terminal device, based on the one or more conditions.

Example 58: The non-transitory program storage device according to example 57, the operations including: receiving from the terminal device, the request during a random access procedure in the cell.

Example 59: The non-transitory program storage device according to any of examples 57 to 58, wherein the cell includes a serving cell or a cell with a PCI different from a PCI of the serving cell.

Example 60: The non-transitory program storage device according to example 58, the operations including: receiving the request via a MAC CE in a message 3 associated with the random access procedure.

Example 61: The non-transitory program storage device according to example 57, the operations including: receiving from the terminal device, the request after a random access procedure in the cell.

Example 62: The non-transitory program storage device according to example 61, the operations including: receiving the request via an uplink MAC CE in the cell.

Example 63: The non-transitory program storage device according to example 62, wherein the uplink MAC CE is multiplexed to an uplink grant on PUSCH in the cell.

Example 64: The non-transitory program storage device according to example 57, wherein the configuration information on the one or more conditions is transmitted via RRC signaling or downlink MAC CE.

Example 65: The non-transitory program storage device according to example 57, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 66: The non-transitory program storage device according to example 65, wherein the current observed downlink timing is based on the timing advance adjustment information on the cell.

Example 67: An apparatus including: at least one processor; and at least one memory including computer program code; wherein the at least one memory and the computer program code are configured to, with the at least one processor, cause the apparatus at least to: apply, by a terminal device, timing advance adjustment information on a cell of a network node; and indicate by the terminal device and to the network node, a request for another timing advance adjustment information to be maintained on the cell.

Example 68: The apparatus according to example 67, wherein the at least one memory and the computer program code are configured to, with the at least one processor, cause the apparatus at least to: indicate to the network node, the request during a random access procedure in the cell.

Example 69: The apparatus according to example 68, wherein the at least one memory and the computer program code are configured to, with the at least one processor, cause the apparatus at least to: transmit the request via a MAC CE in a message 3 associated with the random access procedure.

Example 70: The apparatus according to example 67, wherein the at least one memory and the computer program code are configured to, with the at least one processor, cause the apparatus at least to: indicate to the network node, the request after a random access procedure in the cell.

Example 71: The apparatus according to any of examples 67 to 70, wherein the cell includes a serving cell or a cell with a Physical Cell ID (PCI) different from a PCI of the serving cell.

Example 72: The apparatus according to example 70, wherein the at least one memory and the computer program code are configured to, with the at least one processor, cause the apparatus at least to: transmit the request via an uplink MAC CE in the cell.

Example 73: The apparatus according to example 72, wherein the uplink MAC CE is multiplexed to or transmitted on an uplink grant on PUSCH in the cell.

Example 74: The apparatus according to example 67, wherein the at least one memory and the computer program code are configured to, with the at least one processor, cause the apparatus at least to: determine one or more conditions for triggering the request; and transmit the request based on the determined one or more conditions.

Example 75: The apparatus according to example 74, wherein the at least one memory and the computer program code are configured to, with the at least one processor, cause the apparatus at least to: receive, from the network node, configuration information on the one or more conditions.

Example 76: The apparatus according to example 75, wherein the configuration information on the one or more conditions is received via RRC signaling or a downlink MAC CE.

Example 77: The apparatus according to example 67, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 78: The apparatus according to example 77, wherein the current observed downlink timing is based on the timing advance adjustment information on the cell.

Example 79: An apparatus, including: at least one processor; and at least one memory including computer program code; wherein the at least one memory and the computer program code are configured to, with the at least one processor, cause the apparatus at least to: transmit, from a network node to a terminal device, configuration information including one or more conditions for triggering a request for another timing advance adjustment information to be maintained on a cell of the network node; and receive, by the network node from the terminal device, the request for another timing advance adjustment information to be maintained by the terminal device, based on the one or more conditions.

Example 80: The apparatus according to example 79, wherein the at least one memory and the computer program code are configured to, with the at least one processor, cause the apparatus at least to: receive from the terminal device, the request during a random access procedure in the cell.

Example 81: The apparatus according to any of examples 79 to 80, wherein the cell includes a serving cell or a cell with a PCI different from a PCI of the serving cell.

Example 82: The apparatus according to example 80, wherein the at least one memory and the computer program code are configured to, with the at least one processor, cause the apparatus at least to: receive the request via a MAC CE in a message 3 associated with the random access procedure.

Example 83: The apparatus according to example 79, wherein the at least one memory and the computer program code are configured to, with the at least one processor, cause the apparatus at least to: receive from the terminal device, the request after a random access procedure in the cell.

Example 84: The apparatus according to example 83, wherein the at least one memory and the computer program code are configured to, with the at least one processor, cause the apparatus at least to: receive the request via an uplink MAC CE in the cell.

Example 85: The apparatus according to example 84, wherein the uplink MAC CE is multiplexed to an uplink grant on PUSCH in the cell.

Example 86: The apparatus according to example 79, wherein the configuration information on the one or more conditions is transmitted via RRC signaling or downlink MAC CE.

Example 87: The apparatus according to example 79, wherein the request indicates that the requested another timing advance adjustment information is to be applied for subsequent uplink communication purposes and/or indicates that at least one downlink reference signal is observed to be received by the terminal device with a timing that is different with respect to a current observed downlink timing.

Example 88: The apparatus according to example 87, wherein the current observed downlink timing is based on the timing advance adjustment information on the cell.

References to a ‘computer’, ‘processor’, etc. should be understood to encompass not only computers having different architectures such as single/multi-processor architectures and architectures but also specialized sequential or parallel circuits such as field-programmable gate arrays (FPGAS), (ASICs), signal processing application specific circuits devices and other processing circuitry. References to computer program, instructions, code etc. should be understood to encompass software for a programmable processor or firmware such as, for example, the programmable content of a hardware device whether instructions for a processor, or configuration settings for a fixed-function gate device, array or programmable logic device etc.

The memory(ies) as described herein may be implemented using any suitable storage data technology, such as semiconductor based memory devices, flash memory, magnetic memory devices and systems, optical memory devices and systems, non-transitory memory, transitory memory, fixed memory and removable memory. The memory(ies) may include a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
4G fourth generation
5G fifth generation
5GC 5G core network
ACK acknowledgement
a.k.a. also known as
AMF access and mobility management function
ASIC application-specific integrated circuit
CBRA contention based random access
CC component carrier
CE control element
CJT coherent joint transmission
CORESET control resource set
CP cyclic prefix
CPE customer premises equipment
CPU central processing unit
CSI channel state information
CU central unit or centralized unit
DCI downlink control information
DL downlink
DLRS downlink reference signal
DMRS demodulation reference signal
DSP digital signal processor
DU distributed unit
eNB evolved Node B (e.g., an LTE base station)
EN-DC E-UTRAN new radio—dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FDD frequency-division duplexing
feMIMO further enhanced MIMO
FPGA field-programmable gate array
FR frequency range
FWA fixed wireless access
gNB base station for 5G/NR, i.e., a node providing NR user plane and control plane protocol terminations towards the UE, and connected via the NG interface to the 5GC
HARQ hybrid automatic repeat request
IAB integrated access and backhaul
ID identifier
I/F interface
I/O input/output
JT joint transmission
eLCID extended logical channel ID
LCID logical channel ID
LMF location management function
LTE long term evolution (4G)
MAC medium access control
MIMO multiple input multiple output
MME mobility management entity
msg. 2 message 2, random access response, in a 4-step RACH procedure
msg. 3 message 3, RRC connect request, in a 4-step RACH procedure involving scheduled UL transmission
msg. 4 message 4, contention resolution, in a 4-step RACH procedure
mTRP multi-TRP
MU multi-user
NCE network control element
ng or NG new generation
ng-eNB new generation eNB
NG-RAN new generation radio access network
NR new radio (5G)
NW network
N/W network
OFDM orthogonal frequency division multiplexing
PCI physical cell ID
PDA personal digital assistant
PDCCH physical downlink control channel
PDCP packet data convergence protocol
PHY physical layer
PUCCH physical uplink control channel
PUSCH physical uplink shared channel
qcl quasi-colocation
R reserved or release, depending on context
RA random access
RACH random access channel
RAM random access memory
RAN radio access network
RAN1 radio layer 1
Rel-release
RLC radio link control
ROM read-only memory
RRC radio resource control (protocol)
RS reference signal
RU radio unit
Rx receiver or reception
SGW serving gateway
SMF session management function
SON self-organizing/optimizing network
SpCell special cell
SRI SRS resource indicator
SRS sounding reference signal
SSB synchronization signal block
TA timing advance
TAC timing advance command
TAG timing advance group
TAI timing advance information
TAT time alignment timer
TCI transmission configuration indicator
TDD time division duplex
TPMI transmitted precoding matrix indicator
TRP transmission and/or reception point
TS technical specification
Tx transmitter or transmission
Type-II codebook for CSI feedback to report the wideband and subband amplitude information of selected beams
UE user equipment (e.g., a wireless, typically mobile device)
UL uplink
UPF user plane function
X2 network interface between RAN nodes and between RAN and the core network
Xn network interface between NG-RAN nodes

1-110. (canceled)

111. An apparatus comprising:
at least one processor; and
at least one memory including computer program code;
wherein the at least one memory and the computer program code are configured to, with the at least one processor, cause the apparatus at least to:
apply, by a terminal device, timing advance adjustment information on a cell of a network node; and
indicate by the terminal device and to the network node, a request for another timing advance adjustment information to be maintained on the cell.

112. The apparatus according to claim 111, wherein the at least one memory and the computer program code are configured to, with the at least one processor, cause the apparatus at least to perform one or more of:
Indicate, to the network node, the request during a random access procedure in the cell; or
Indicate, to the network node, the request after a random access procedure in the cell.

113. The apparatus according to claim 112, wherein the at least one memory and the computer program code are configured to, with the at least one processor, cause the apparatus at least to perform one or more of:
transmit the request via a MAC CE in a message 3 associated with the random access procedure; or
transmit the request via an uplink MAC CE in the cell.

114. The apparatus according to claim 113, wherein the uplink MAC CE is multiplexed to or transmitted on an uplink grant on PUSCH in the cell.

115. The apparatus according to claim 111, wherein the cell comprises a serving cell or a cell with a Physical Cell ID (PCI) different from a PCI of the serving cell.

116. The apparatus according to claim 111, wherein the at least one memory and the computer program code are configured to, with the at least one processor, cause the apparatus at least to:
determine one or more conditions for triggering the request; and
transmit the request based on the determined one or more conditions.

117. The apparatus according to claim 116, wherein the at least one memory and the computer program code are configured to, with the at least one processor, cause the apparatus at least to:
receive, from the network node, configuration information on the one or more conditions, wherein the configuration information on the one or more conditions is received via RRC signaling or a downlink MAC CE.

118. The apparatus according to claim 111, wherein the requesting for the another timing advance adjustment information enables configuring of the terminal device to maintain another timing advance loop in addition to a timing advance loop already maintained with the cell.

119. The apparatus according to claim 118, wherein an uplink with another timing value and a current uplink timing value at any given time are maintained and updated independently by the network node.

120. The apparatus according to claim 111, wherein the another timing advance adjustment information having a timing advance value different from a current observed downlink timing value currently used by the terminal device.

121. The apparatus according to claim 120, wherein the request indicates that the requested another timing advance adjustment information is to be applied for subsequent uplink communication purposes and/or indicates that at least one downlink reference signal is observed to be received by the terminal device with the another timing advance value that is different with respect to the current observed downlink timing.

122. The apparatus according to claim 119, wherein the terminal device is configured to trigger the indication for the another timing advance loop when the terminal device receives a downlink MAC control element (MAC CE) activating at least a second transmission control information (TCI) state, and the terminal device observes a timing difference for the downlink referenced signal (DL RS) indicated by a first TCI state and a second TCI state that exceeds a configured threshold condition or criteria.

123. The apparatus according to claim 112, wherein the threshold conditions or criteria comprises one of:
when the timing difference is more than a defined nanoseconds or microseconds, and when the timing difference is more than a defined number of timing advance (TA) steps between the DL_RS that are associated with the PUCCH/PUSCH transmission for the terminal device.

124. The apparatus according to claim 112, wherein a configured condition for indicating the another timing advance loop comprises: the network activating at least the second TCI state or multiple TCI states and the terminal device is configured to observe the timing difference that exceeds a defined number of steps for the DL_RS, or wherein the downlink MAC CE activates at least a second transmission configuration indicator (TCI) state to indicate one or more downlink reference signals.

125. An apparatus, comprising:
at least one processor; and
at least one memory including computer program code;
wherein the at least one memory and the computer program code are configured to, with the at least one processor, cause the apparatus at least to:
transmit, from a network node to a terminal device, configuration information comprising one or more conditions for triggering a request for another timing advance adjustment information to be maintained on a cell of the network node; and
receive, by the network node from the terminal device, the request for another timing advance adjustment information to be maintained by the terminal device, based on the one or more conditions.

126. The apparatus according to claim 115, wherein the at least one memory and the computer program code are configured to, with the at least one processor, cause the apparatus at least to perform one or more of:
receive from the terminal device, the request during a random access procedure in the cell; or
receive from the terminal device, an indication from the request after a random access procedure in the cell.

127. The apparatus according to claim 116, wherein the at least one memory and the computer program code are configured to perform one or more of:
receive from the terminal device, the request via a MAC CE in a message 3 associated with the random access procedure; or
transmit to the terminal device, configuration information on the one or more conditions.

128. The apparatus according to claim 115, wherein the cell comprises a serving cell or a cell with a PCI different from a PCI of the serving cell.

129. The apparatus according to claim 118, wherein the uplink MAC CE is multiplexed to an uplink grant on PUSCH in the cell.

130. The apparatus according to claim 115, wherein the requesting for the another timing advance adjustment information enables configuring of the terminal device to maintain another timing advance loop in addition to a timing advance loop already maintained with the cell.
